(19) United States
(12) Patent Application Publication
(10) Pub. No.: US 2010/0120968 A1
(43) Pub. Date: May 13, 2010

(54) WETTING AND SURFACE TENSION REDUCING AGENT

(75) Inventor: Peter Clifford Hodgson, New South Wales (AU)

Correspondence Address: DARBY & DARBY P.C., P.O. BOX 770, Church Street Station, New York, NY, 10008-0770, US

(73) Assignee: ADVANCE COMPOSITES INTERNATIONAL PTY LTD, Brisbane, Queensland (AU)

(21) Appl. No.: 12/529,624

(22) PCT Filed: Feb. 29, 2008
(86) PCT No.: PCT/AU2008/000272

§ 371 Date: Sep. 2, 2009

(30) Foreign Application Priority Data
Mar. 2, 2007 (AU) 2007901075

(51) Int. Cl. C08K 3/40; C08L 83/00; C08L 83/06

(52) U.S. Cl. 524/494; 524/500; 524/506

(57) ABSTRACT

The present invention relates to a surface tension modifier for use in liquid curable composite materials, wherein the modifier is the reaction product between a polyol and an organo-functional silane. The present invention also relates to a method for producing a fibre reinforced composite material, and a fibre reinforced composite material when produced by the method. The method comprises the steps of contacting a plurality of reinforcing fibres with a curable resin mixture and curing the curable resin mixture, wherein the curable resin mixture comprises a curable resin and a predetermined quantity of the surface tension modifier of the invention. The present invention further relates to a method of improving wettability of a resin and use of the surface tension modifier of the invention.

### FIELD OF THE INVENTION

The present invention relates to reinforced composite materials, and in particular to fibre reinforced polymer composites. However, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Fibre reinforced polymer composites are known in the art and are commonly made by reacting a curable resin with a reactive diluent in the presence of a free radical initiator. Reinforcing materials such as glass fibre are also included in the formulations to provide dimensional stability and toughness. Typically, the curable resin is an unsaturated polyester resin and the reactive diluent is a vinyl monomer. However, other thermoset resins may be used, such as acrylic, vinyl ester resins or epoxy resins. Such reinforced composites are used in many key industrial applications, including: construction, automotive, aerospace, marine and for corrosion resistant products.

There are primarily two methods for applying fibreglass reinforcements to open moulds, viz a manual layering technique and a “spray-up” technique. The manual layering technique is generally referred to as “hand lay-up” which entails pre-catalysing the resin in a pail and then pre-wetting a cured gel coat by using a brush, nap roller or wet-out gun. A pre-cut “sheet” of mat or woven reinforcing fibres is placed onto the resin-wetted gel coat and is wet-out again. Compaction of the glass/resin and removal or air voids is accomplished by one of two methods: 1.) if the laminate is a mat, a consolidating roller and/or a brush may be used with a stippling (tapping) motion; 2.) if the laminate contains woven reinforcing fibres, the fabric is placed behind the mat and then a squeegee may be used. As the skilled addressee will appreciate, proper wet out of the fibreglass with resin is critical to the success of the part being fabricated, and mechanical consolidation using a roller, brush or squeegee in hand lay-up is almost essential for removing voids, smoothing the surface, and insuring proper integration of resin and reinforcing material (see “Waste Reduction Strategies For Fiberglass Fabricators” D. Hillis and G. Hunt, ECU, Department of Industrial Technology-www.p2pays.org/ref/01/00368.pdf).

The “spray-up” method may be employed as an alternative to the “hand lay-up” in which short glass fibres and resin are deposited simultaneously with catalysed resin onto a cured gel coat. This is performed by a hand-operated chopper gun which simultaneously chops glass roving and sprays catalysed resin such that the two merge and are directed by the operator onto the mould (see FIGS. 1 and 2). This process requires the least amount of labour since there is no need for hand tailoring of glass or hand application of resin. However, it is generally more difficult to maintain tolerances in laminate thickness than the “hand lay-up” method and entrapped air bubbles or voids are always an issue until such time as the deposited laminate is suitably mechanically consolidated.

To overcome these shortcomings, a number of potential solutions have been proposed in the art. For example, U.S. Pat. No. 4,917,764 teaches a binder for glass fibre mats having improved strength and fibre wettability. The improved wettability appears to be due to the addition of between 1% and 6% of a carboxylated styrene-butadiene latex having a glass transition temperature (Tg) less than 25° C. and a surface tension less than 50 dynes/cm. Alternative approaches relate to the use of sizing agents to coat the fibres to improve compatibilization between the fibre and the resin. For example U.S. Pat. No. 5,491,182 teaches sizing compositions which provide improved wettability of glass fibres, and U.S. Pat. No. 4,842,934 teaches the use of silane treated polyester fibres having enhanced wettability. However, none of the above-mentioned prior art teaches a process for applying a structural laminate that does not require mechanical consolidation or at least reduced mechanical consolidation.

It is an object of the present invention to overcome or ameliorate at least one of the disadvantages of the abovementioned prior art, or to provide a useful alternative.

### DISCLOSURE OF THE INVENTION

According to a first aspect the present invention provides a method for producing a fibre reinforced composite material, comprising: contacting a plurality of reinforcing fibres with a curable resin mixture and curing said curable resin mixture, said curable resin mixture comprising a curable resin and a predetermined quantity of surface tension modifier prepared by reacting a polyol with an organo-functional silane.

According to a second aspect the present invention provides a method for producing a composite material, comprising: combining a plurality of reinforcing fibres with a curable resin mixture to form a composition; applying said composition to a mould and curing said curable resin, said curable resin mixture comprising a curable resin and a predetermined quantity of surface tension modifier prepared by reacting a polyol with an organo-functional silane.

Preferably the predetermined quantity of the surface tension modifier combined with the curable resin is a sufficient amount to lower the surface tension of the curable resin such that the curable resin substantially wets out and permeates/penetrates the reinforcing fibres with reduced mechanical consolidation during application. In preferred embodiments the fibres are saturated with resin with no applied mechanical consolidation during application.

According to a third aspect the present invention provides a liquid curable resin mixture for production of composite articles, comprising: a curable resin and a predetermined quantity of surface tension modifier prepared by reacting a polyol with an organo-functional silane.

According to a fourth aspect the present invention provides a surface tension modifier for use in liquid curable composite materials, said modifier being the reaction product between a polyol and an organo-functional silane.

The reinforcing fibres are preferably glass fibres chosen from E-, S- or C-class glass, optionally coated with a coupling agent. The glass fibre length may be between about 5 to 50 millimetres however it will be appreciated that the fibre length is not limited to this range. The glass fibre may be in the form of a woven glass roving, a chopped strand mat, a bi-directional mat, a uni-directional mat, or combinations thereof. A preferred coupling agent comprises a plurality of molecules, each having a first end adapted to bond to the glass fibre and a second end adapted to bond to the resin when cured. Preferably the coupling agent is Dow® Z-6030 (methacryloxypropyltrimethoxysilane). However, other coupling agents may be used such as Dow® Z-6032, and Z-6075 (vinyl triacetoxy silane). Similar coupling agents are available from DeGussa® and Crompton® Specialties, for example Dynasylan® OCTEO (Octyltriethoxysilane), DOW® Z6341 (octyltriethoxysilane), Dynasylan® GLYMO (3-glycidyloxypropyltrimethoxysilane), DOW® Z6040 (glycidoxypropyltrimethoxysilane), Dynasylan® IBTEO (isobutyltriethoxysilane), Dynasylan® 9116 (hexadecyltrimethoxysilane), DOW® Z2306 (i-butyltrimethoxysilane), Dynasylan® AMEO (3-aminopropyltriethoxysilane), DOW® Z6020 (aminoethylaminopropyltrimethoxysilane), Dynasylan® MEMO (3-methacryloxypropyltrimethoxysilane), DOW® Z6030, DOW® Z6032 (vinylbenzylaminoethylaminopropyltrimethoxysilane), DOW® Z6172 (vinyl-tris-(2-methoxyethoxy) silane), DOW® Z6300 (vinyltrimethoxysilane), DOW° Z6011 (aminopropyltriethoxysilane) and DOW° Z6075 (vinyl triacetoxy silane). Other coupling agents would be apparent to the skilled person, such as titanates and other organo-metal ligands.

In a preferred embodiment the surface tension (or contact angle) of the curable resin is lower when modified with the surface tension modifier when compared with an unmodified curable resin. The contact angle of the resin may be defined as the angle between the liquid (the resin) and a solid (the glass fibres) at the solid-liquid-gas interface. The contact angle is typically acute for a relatively wetting resin (where the liquid adheres to the surface) and obtuse for a relatively nonwetting resin (where the liquid does not adhere). The wettability of the glass fibres is improved by reducing the surface tension of the resin when between about 1 and 5% of a surface tension modifier is added to the resin. However, it will be appreciated that as little as 0.1% of the surface tension modifier of the invention to up to about 20% can be added. In some embodiments the surface tension modifier of the invention can be added at 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5 or 20%. In other embodiments the surface tension modifier of the invention can be added at between about 1 to about 1.5, 1.5 to about 2, 2 to about 2.5, 2.5 to about 3, 3 to about 3.5, 3.5 to about 4, 4 to about 4.5, 4.5 to about 5, 5 to about 5.5, 5.5 to about 6, 6 to about 6.5, 6.5 to about 7, 7 to about 7.5, 7.5 to about 8, 8 to about 8.5, 8.5 to about 9, 9 to about 9.5, 9.5 to about 10, 10 to about 10.5, 10.5 to about 11, 11 to about 11.5, 11.5 to about 12, 12 to about 12.5, 12.5 to about 13, 13 to about 13.5, 13.5 to about 14, 14 to about 14.5, 14.5 to about 15, 15 to about 15.5, 15.5 to about 16, 16 to about 16.5, 16.5 to about 17, 17 to about 17.5, 17.5 to about 18, 18 to about 18.5, 18.5 to about 19, 19 to about 19.5, or 19.5 to about 20%. The preferred surface tension modifier is synthetically prepared by reacting a polyol with a trialkoxysilane (RSi(OR′)₃) in the presence of a catalyst, such as tri-butyl tin, and heat. The polyol may be a tri-hydroxy compound, such as trimetholylpropane, or a tetra-hydroxy compound, such as pentaerythritol. However, it will be appreciated that other polyols fall within the purview of the present invention, for example dihydroxy compounds and substituted hydroxy-functional compounds. The trialkoxysilane silane is preferably chosen from the group consisting of Dynasylan® Octeo (Degussa) (a monomeric medium chain length alkyl functional silane) or Dynasylan 9116. The reaction between the polyol and the trialkoxysilane may be partial or complete.

The surprising improvements that the present invention provides can be seen in relatively simple wicking experiments. To explain, in one set of comparative tests a strand of fibreglass was partially immersed in liquid resin and the degree to which the resin wicks up the strand of fibreglass was noted. It was found that resin untreated according to the present invention typically wicks less than about 0.5 mm. However, it was found that the same resin treated with the surface tension modifier of the present invention wicks up the strand of fibreglass to about 2 to 4 mm in height. This clearly demonstrates the improvements in reduction of contact angle which the present invention provides. Other tests to demonstrate the effects of the surface tension modifier of the invention comprise “sprinkling” fibreglass strands onto a resin treated and not treated with surface tension modifier of the invention. When under flexural load, the fibres immersed into the treated resin show little or no debonding post curing of the laminate, however, the fibres in the untreated resin show visible jackstrawing/debonding due to forces generated as the resin shrinks during the curing reaction or when the cured panels were strained below their yield point.

The skilled person will appreciate that the contact angle is also affected by the surface energy of the glass. For example, for a given resin, the higher the surface energy of the glass the lower the contact angle of a resin wetting the glass. The lower the contact angle the better the wetting. It is important that the glass surface has a high population of unbound silanol moieties. These silanol moieties are prime sites for hydrogen bonding with suitable components of the resin. The presence of these silanol groups enhances the adhesive forces between the resin and the glass. This hydrogen bonding/increased adhesive forces augments the low surface energy of the resin and further aids wetting.

The curable resin may be a single resin or a resin system and is preferably chosen from a liquid unsaturated polyester resin or a liquid vinyl ester resin. In one example the resin is Derakane® epoxy vinyl ester resin 411-350 (Ashland Chemicals). In another example, the resin may be general purpose unsaturated polyester laminating resins manufactured by RYCOL®, AOC®, COOKS COMPOSITES®, ETERSET®, NAN YAR®, DSM®, TOTAL®, NUPLEX®, etc. The present applicant contemplates that all laminating unsaturated polyester and vinyl ester resins considered suitable by their manufacturers for use in open moulding applications would be suitable for the present invention. However, low molecular weight resins are preferred since they have lower high shear viscosities for a given monomer content, and the lower the high shear viscosity the better the wetting (all other things equal).

In related embodiments at least one reactive diluent and/or thixotropic agent and/or de-aeration additive is incorporated into the curable resin. For example, suitable thixotropic agents may be silica or precipitated silica, but preferably organic thixatropes such as hydrogenated caster oils and amide thixatropes.

Suitable reactive diluents may be chosen from the following monomers: ethyl acrylate, butyl acrylate, HEMA, IBMA, MMA, isobornyl methacrylate and styrene. The applicant has determined that these particular monomers are very effective in assisting the surface tension-modified resin wet the glass fibres. About 5% to about 30% of a reactive diluent may be added to the resin. However, it will be appreciated the invention is not limited to the aforementioned range or types of monomers.

The skilled person will appreciate that addition of a reactive diluent will reduce the viscosity of the curable resin, and it will also be appreciated that the viscosity of a curable resin is a different property to its surface tension. Viscosity of a liquid is a measure of its inability to flow and surface tension is the energy required to stretch a unit change of the surface area. It is commonly accepted that there is no direct correlation between viscosity and surface tension, and that these two properties are independent of each other. Therefore, whilst the addition of a reactive diluent to a curable resin will go part way to improving wettability, modifying the surface tension of the curable resin plays a greater role in affecting the wettability of the glass reinforcing fibres.

The applicants have found that the present invention provides a reinforced composite material which requires reduced or no mechanical consolidation during application as compared to traditional prior art glass reinforced composite materials. Furthermore, the present invention retains or improves mechanical properties, such as strength and toughness, chemical properties, and aesthetic properties such as surface finish. Further still, since little or no mechanical consolidation is now required the applicant believes that a 30 to 40% reduction in VOC emissions is possible.

It will also be clear to persons skilled in the art that by appropriate dosing of the curable resin with the surface tension modifier, production of composite articles is simplified and speed of production increased by reducing or eliminating the need for mechanical consolidation of the reinforcing fibres in the curable resin. This mechanical consolidation which is required for conventional processes substantially contributes to the length of time required to produce such composite articles. Clearly use of the surface tension modifier provides a significant advance over conventional systems. For example, in one test the present applicant found that a square meter of mould could be sprayed with resin containing the surface tension modifier of the invention and glass. It was found that the resin deaerated and consolidated within about 5 minutes, with no mechanical consolidation. For large moulds e.g. swimming pools and yacht hulls, in practice typically three laminators are typically required to keep up with a gun operator. However, using the surface tension modifier of the invention it was found that only one laminator was required to keep up with the gun operator, and the laminator was only required to consolidate the laminate into the tight corners of the mould. This represents clear saving in manpower, and therefore corresponding reductions in cost and time to produce large moulded items.

According to a fifth aspect the present invention provides improving wettability of a resin comprising adding to said resin a predetermined quantity of surface tension modifier being a reaction product between a polyol and an organo-functional silane.

As discussed above the preferably the predetermined quantity such that mechanical consolidation of a fibre in the resin is eliminated or at least reduced.

According to a sixth aspect the present invention provides a fibre reinforced composite material when produced by a method according to the first aspect.

According to a seventh aspect the present invention provides a composite material when produced by a method according to the second aspect.

According to an eighth aspect the present invention provides use of a surface tension modifier for improving wettability of a resin comprising adding to said resin a predetermined quantity of said surface tension modifier, wherein said surface tension modifier is a reaction product between a polyol and an organo-functional silane.

According to a ninth aspect the present invention provides a composite article when made from the liquid curable resin mixture according to the third aspect.

Without wishing to be bound by theory, the development of a sufficient mechanical interaction between the resin matrix and the fibre reinforcement in a composite material depends on the efficiency of adhesion at the interface, and the relative surface energies of the fibre and resin is one factor influencing the formation of these mechanical interactions. The Applicant contemplates that the surface energy of the resin influences both the processing and final properties of a composite material, and that flow of resin through a fibre mat can be affected by the wetting properties of the resin.

The person skilled in the art would appreciate that the present invention also finds utility in other processes and systems, for example in wetting glass reinforcement in resin infusion processes in closed moulding processes and vacuum infusion processes. This may be achieved since the modifier of the invention tends to minimise the formation of air voids during the infusion process and in the subsequent curing process. The present applicant contemplates that relatively reduced amounts of the surface tension modifier according to the present invention can be used to the same effect as a resin having a total predetermined concentration. For example, the fibres themselves may be pre-treated with the modifier of the invention and the bulk resin left untreated. Alternatively, the fibres may have a coupling agent coating the fibres which is “infused” with the modifier of the invention. In these examples the fibres would act as carriers for the surface tension modifier and the modifier would leach off the fibres (or out of the coating to which it is infused) and into the resin adjacent the fibres and would assist in wettability as described above.

According to a tenth aspect the present invention provides a method for producing a fibre reinforced composite material, comprising: contacting a plurality of reinforcing fibres with a curable resin mixture and curing said curable resin mixture, said reinforcing fibres comprising a coating of a surface tension modifier prepared by reacting a polyol with an organo-functional silane.

According to a eleventh aspect the present invention provides a method for producing a composite material, comprising: combining a plurality of reinforcing fibres with a curable resin mixture to form a composition; applying said composition to a mould and curing said curable resin, said reinforcing fibres comprising a coating of surface tension modifier prepared by reacting a polyol with an organo-functional silane.

According to a twelfth aspect the present invention provides a fibre reinforced composite material when produced by a method according to the tenth aspect.

According to a thirteenth aspect the present invention provides a composite material when produced by a method according to the eleventh aspect.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

Other than in the examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

In describing and claiming the present invention, the following terminology will be used in accordance with the definitions set out below. It is also to be understood that the terminology used herein is for the purpose of describing particular embodiments of the invention only and is not intended to be limiting.

Throughout this specification the terms “fibre” and “fibres” are to be taken to also include platelet and platelets respectively. It will be appreciated by one skilled in the art that the term fibre should also be construed to incorporate spherical glassy components, such as cenospheres, zenospheres and plerospheres. Other spherical additives are glass beads and micro balloons (microscopic glass beads), which may be sourced from fly ash or bottom ash.

Glass fibres are the most suitable fibres for the invention. However other mineral fibres such as wollastonite and ceramic fibres may also be used without departing from the scope of the invention. The terms “fibre” and “filament” may be used interchangeably herein and includes chopped bundles of fibres and individualised filaments or fibres.

The term “mechanical consolidation” as used herein refers to a mechanical process of compacting or saturating reinforcing fibres with a liquid curable resin such that the fibres are substantially homogenously distributed throughout the liquid curable resin. For example, one common mechanical consolidation process is the “hand lay up” method of fabrication in which reinforcing fibres are added to an open mould and the liquid curable resin system is “wetted out” on the reinforcing fibres by, for example, hand rollers, brushes and squeegees.

The terms “wettability”, “wetting out”, “wet through” etc as used herein refers to the relative degree to which a resin will spread onto or coat the reinforcing fibres and penetrate bundles of filaments. Wettability may be expressed as a contact angle which may be defined as the angle between a liquid (the resin) and a solid (the glass fibres) at the solid-liquid-gas interface. The contact angle is acute for wetting (where the liquid adheres to the surface) and obtuse for nonwetting (where the liquid does not adhere). For example poor wettability (a relatively high surface tension) may have a contact angle about >30° and good wettability (a relatively low surface tension) may have a contact angle about <30°. An increase in wettability may be considered to be an increase in the adhesion force between two different materials.

The terms “jackstrawing” and “spiderwebbing” are terms of art used to describe a fibreglass surface having turned white in the laminate because the glass has separated from the resin.

Throughout this specification the terms “property” and “properties” are to be taken to include typical mechanical, physical and chemical properties of polymers and cured resins. For example, mechanical properties are those selected from the group consisting of flexural and/or tensile strength, toughness, elasticity, plasticity, ductility, brittleness and impact resistance. Chemical and physical properties are those selected from the group consisting of density, hardness, cross-link density, molecular weight, chemical resistance and degree of crystallinity.

### BRIEF DESCRIPTION OF THE DRAWINGS

Preferred embodiments of the invention will now be described, by way of example only, with reference to the accompanying drawings in which:

FIG. 1 is a close-up photograph of a typical glass fibre spray gun shown spraying chopped glass fibres and catalysed resin onto an open mould. Note the white colouring of the freshly deposited laminate, which is also visible in FIGS. 2 and 3A.

FIG. 2 is another photograph of an operator spraying glass fibres and catalyzed resin onto a mould. Note the white colour of the freshly deposited laminate which contrasts with the underlying consolidated laminate ahead of the chopper gun operator.

FIG. 3A shows resin and fibreglass being sprayed simultaneously onto a mould in a typical deposition process, significant amounts of air are entrapped in the laminate during this process resulting in the white colour of the freshly deposited laminate.

FIG. 3B is a view of the laminate of FIG. 3A post mechanical consolidation showing that the consolidated laminate is darker than the freshly deposited laminate since the entrained air has been rolled out using a roller.

FIG. 4 shows a selection of tools used to mechanically consolidate a laminate, comprising brushes, rollers and squeegees.

FIG. 5 is a close-up view of a cured laminate having a commercially available surface tension modifier prepared by the spray-up method showing debonded reinforcing fibres and the presence of unwanted microbubbles (no mechanical consolidation has been applied).

FIG. 6 is a close-up view of a cured laminate prepared identically to the laminate as shown in FIG. 5 but having the surface tension modifier according to the present invention. The laminate has “self-consolidated” without the need for mechanical/manual consolidation.

FIG. 7 is a close-up view of a cured laminate prepared by depositing glass fibre onto wet catalysed resin having the surface tension modifier according to the present invention (no mechanical consolidation has been applied). Again note the lack of entrained air bubbles and that the fibres have been thoroughly wetted out and wet through.

### BEST MODE FOR CARRYING OUT THE INVENTION

The present invention provides a method for producing a fibre reinforced composite material and the fibre reinforced composite produced by the method. The method comprises the steps of: contacting a plurality of reinforcing fibres with a curable resin mixture and curing the curable resin mixture. The curable resin mixture comprises a curable resin and a predetermined quantity of surface tension modifier prepared by reacting a polyol with an organo-functional silane. The reinforcing fibres are preferably glass fibres, optionally coated with a coupling agent such as Dow® Z-6030. The glass fibre length is preferably 25 mm however may be as long as 50 mm. One preferred curable resin is Derakane® epoxy vinyl ester resin 411-350 (Ashland Chemicals). However, all laminating unsaturated polyester and vinyl ester resins considered suitable by their manufacturers for use in open moulding applications would be suitable for the present invention.

Because the wettability of the resin is primarily related to the difference in surface tensions of the resin and the glass, the choice of glass roving to use with the resin modified according to the present invention is relatively important. The higher the surface energy of the glass fibres the better the wetting since this will reduce the contact angle between the resin and the glass fibres. (The lower the contact angle the better the wetting). In addition, the fibre reinforcement should have minimal sizing such that bundles (strands/subtext) of individual glass fibres readily dissociate into the individual filaments/fibres. The glass fibres should be “soft” and resist the build-up of static electricity. Preferably, the glass fibres are trialed with the surface energy modified resin according to the present invention to determine its suitability.

In a preferred embodiment the surface tension (or contact angle) of the curable resin is lower when modified with the surface tension modifier according to the present invention when compared with an unmodified curable resin. In other words, the wettability of the glass fibres is improved by reducing the surface tension of the resin such that the curable resin substantially wets out and permeates the reinforcing fibre with reduced mechanical consolidation during application. In preferred embodiments the fibres are saturated with resin with no applied mechanical consolidation during application. Preferably about 0.5% and 5% (w/w) of a surface tension modifier is added to the resin to provide the improved wettability. The preferred surface tension modifier is synthetically prepared by reacting the polyol pentaerythritol with the organo-functional silane Dynasylan® Octeo (Degussa) (a monomeric medium chain length alkyl functional silane) or Dynasylan 9116 in the presence of a tin catalyst.

Preferably, the various settings on the spray up depositor are carefully set prior to applying modified resin and glass reinforcing fibre. In preferred embodiments only one “cheese”/“spool” of glass roving should enter the chopper motor through the centre portal. This is necessary to prevent “horns” from forming in the deposited laminates from where the chopped glass fibre from one “cheese” overlaps the chopped glass fibre from a second “cheese”. Chopping one roving produces a significantly more even glass distribution on the mould. The present applicant has determined that chopping only one roving does not dramatically reduce the glass deposition rate since the air motor driving the chopper naturally speeds up. The depositor must be set up in such a way that it is delivering the required resin-to-glass ratio “off the gun”. Preferably no further wet-out of the deposited laminate is required. In addition, the laminate should be deposited in approximately 1 mm passes. This does not slow down the process when spraying up large objects such as tanks, boat hulls, swimming pools or large panels etc. because the laminate does not require hand consolidation. Additionally, the gel-time of the resin can advantageously be reduced to less than 10 minutes, allowing for multiple layers to be deposited without stopping the process.

In related aspects the present invention provides a method for producing a composite material and the composite material when produced by the method. The method comprises the steps of: combining a plurality of reinforcing fibres with a curable resin mixture to form a composition; applying the composition to a mould and curing the curable resin.

Preferably the viscosity of the curable resin is reduced to assist in wetting of the glass fibres. For example about 5% to about 30% of one or more reactive diluents may be added to the curable resin, and may be chosen from the following monomers: ethyl acrylate, butyl acrylate, HEMA, IBMA, MMA, isobornyl methacrylate and styrene. However, IBMA is preferred. Further, low molecular weight curable resins are preferred for assisting in wetting of the glass. Further still, at least one thixotropic agent is preferably incorporated into the curable resin. Yet further still, the glass fibre is preferably pre-treated to ensure that the glass surface is populated with unbound silanol moieties, which are sites for hydrogen bonding with components of the curable resin.

### EXAMPLES

The present invention will now be described with reference to the following examples which should be considered in all respects as illustrative and non-restrictive.

### Conventional Fibreglass Fabrication

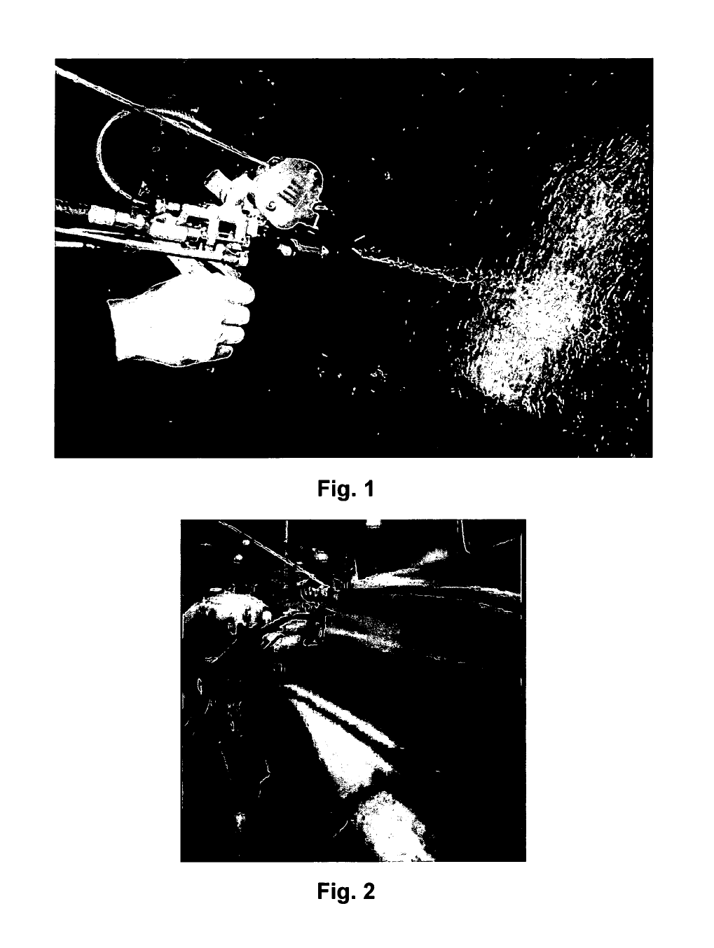

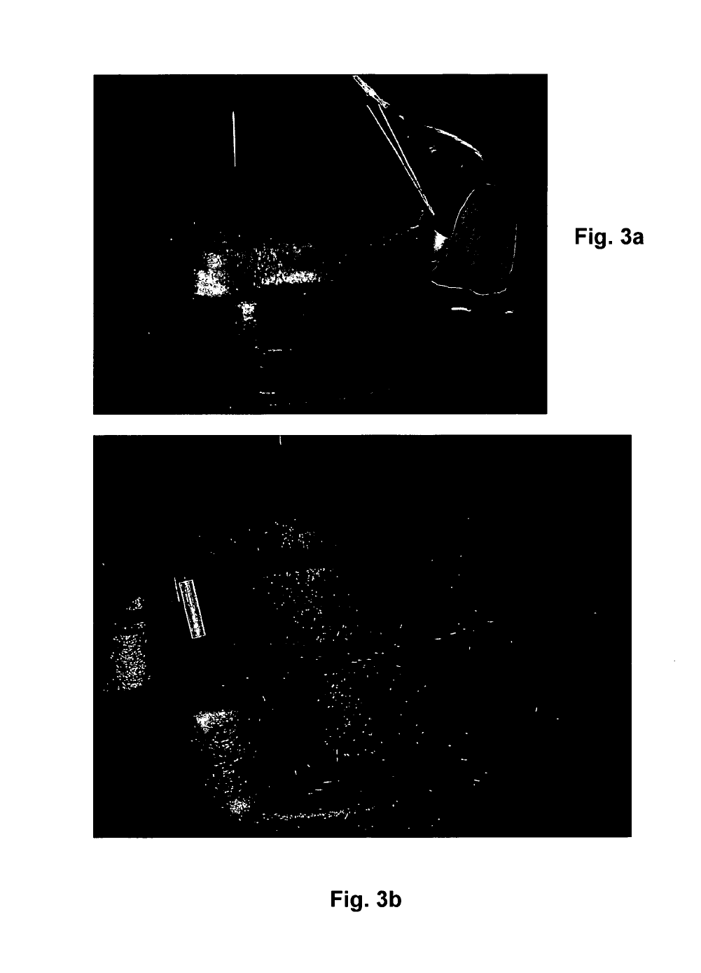

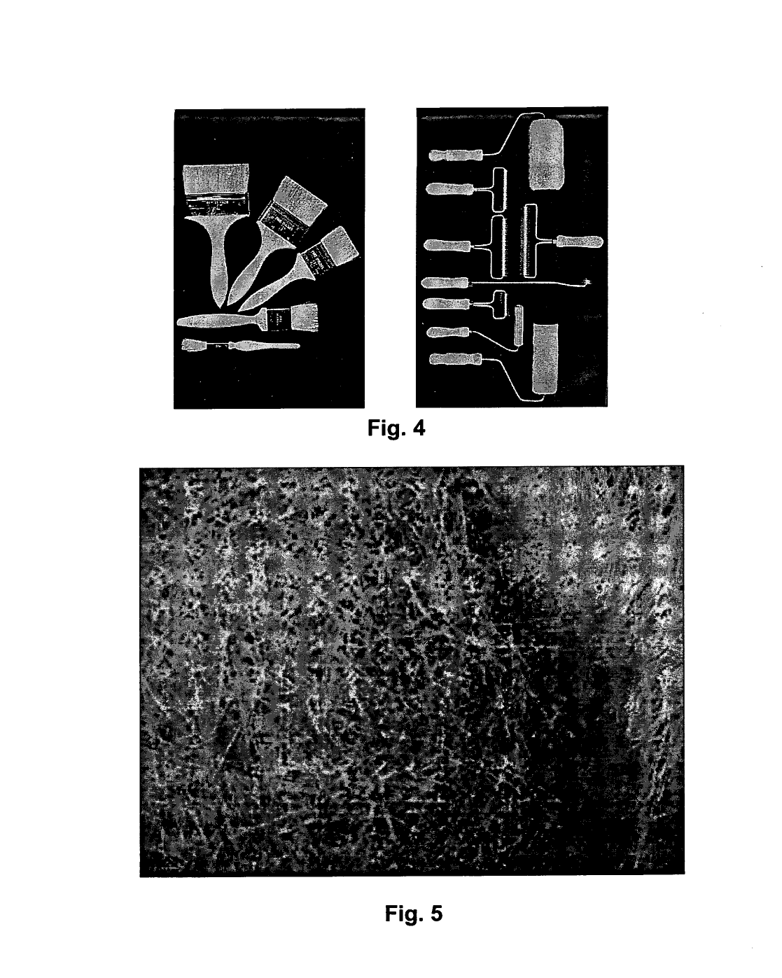

Referring to FIGS. 1 to 3, it can be seen that the glass reinforcing fibre sprayed/deposited with resin onto an open mould resists “laying down” and wetting by the resin. It can also be seen that a significant quantity of air is entrained into the laminate by this spraying process. It is clear from these photographs that the laminate must be mechanically consolidated by simultaneously rolling out the air and intimately mixing the glass and the resin. Typical instruments used in the mechanical consolidation process are shown in FIG. 4.

Fibreglass Fabrication with Dynasylan Octeo Surface Tension Modified Resin

A 1% addition of Dynasylan® Octeo was added to a general purpose unsaturated polyester (UP) laminating resin and glass reinforcing fibres were then sprayed simultaneously onto a gel coat using a Glass Craft depositor. The Dynasylan® Octeo was found to be sufficient to improve wet-out of the glass roving to the naked eye. However, whilst not visible to the naked eye prior to curing, micro air bubbles appeared during the exothermic stage of the curing cycle resulting in significant “jackstrawing”/“spider webbing”. See FIG. 5 for a close up view of a panel prepared using a 1% addition of Dynasylan® Octeo showing debonding of the fibres and a plurality of microbubbles. Note: no mechanical consolidation was applied to this panel. The skilled person will appreciate that debonded fibres and microbubbles are deleterious to the physical properties of a panel. For example it has been estimated that a 15% to 20% reduction in mechanical strength results when debonded fibres are present, i.e. typical laminate strength in flexure is less than or equal to about 170 MPa. However, a more significant issue with jackstrawing/spiderwebbing is a dramatic reduction in the chemical resistance which is believed to be caused by oxygen inhibition of the curing process on the inside surfaces of these air bubbles. Further, since air bubbles tend to form and remain at the interface between the laminates, “blisters” appear on the surface of the gel coat above the air void reducing the aesthetic appeal of the laminates.

Fibreglass Fabrication with the Surface Tension Modifier Incorporated Into the Resin

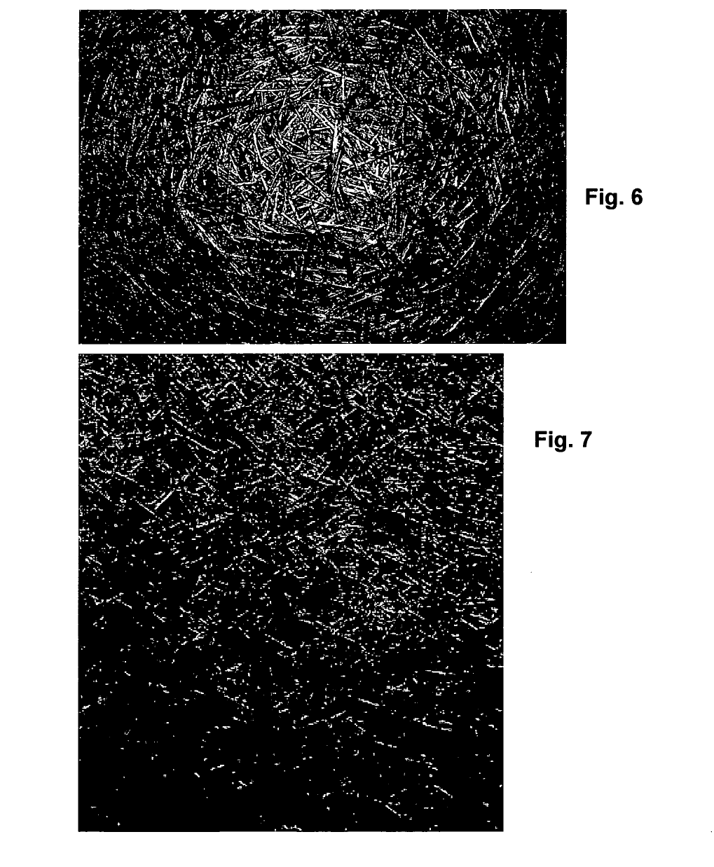

FIG. 6 shows a laminate made with a 1% addition of the surface tension modifier according to the present invention. In particular, an adduct prepared by reacting Dynasylan® Octeo with pentaerythritol. The laminate in FIG. 6 was prepared in exactly the same way as the laminate shown in FIG. 5 having the jackstrawing/spiderwebbing, however, note that in FIG. 6 there is no visible jackstrawing or entrained air. FIG. 7 shows a neo-pentyl glycol laminating resin modified with 1% of the surface tension modifier according to the present invention deposited together with chopped roving (glass fibre reinforcement) onto a mould. The flexural strengths of these surface tension modified laminates (shown in FIGS. 6 and 7) are greater than 170 MPa.

Comparing FIGS. 1, 2 and 3 with FIGS. 6 and 7 it is clear that a resin modified with the additive according to the present invention is capable of wetting the reinforcing fibres significantly better than an unmodified resin or a resin modified only with Dynasylan® Octeo.

### Reaction Conditions for the Preparation of the Surface Tension Modifier

Whilst a preferred surface tension modifier is prepared by reacting Dynasylan® Octeo with pentaerythritol, other modifiers can be prepared with similar performance. Other preferred organo functional silanes are those containing a carbon carbon double bond, or an epoxy group or an amine functional group. For example, Dynasylan® OCTEO (or DOW® Z6341) the active ingredient of which is triethoxyoctyl silane; Dynasylan® GLYMO (or DOW® Z6040) the active ingredient of which is glycidoxy (epoxy) functional methoxy silane; Dynasylan® IBTEO (or DOW® Z2306) the active ingredient of which is triethoxyisobutyl silane; Dynasylan® AMEO (or DOW® Z6020) the active ingredient of which is 3 aminopropyltriethoxysilane; Dynasylan® MEMO (or DOW® Z6030) the active ingredient of which is methacryloxypropyltrimethoxysilane; DOW® Z6032 the active ingredient of which is cationic styrlamine functional silane, DOW® Z6172, DOW® Z6300, DOW° Z6011 Aminopropyltriethoxysilane, DOW® Z6075 Vinyltriacetoxysilane, and other vinyl, epoxy, amine or alkyl function silanes. However, it will be appreciated that this is not an exhaustive list.

A preferred surface tension modifier was prepared according to the following procedure: a solution of Dynasylan® Octeo was reacted with pentaerythritol in the presence of a tributyl tin catalyst and heated slowly from 100° C. to 160° C. until no more ethanol is liberated. The skilled person will appreciate how to react a polyol and an organo-functional silane with minimal crosslinking/gel formation, i.e. by having a reaction stoichiometry rich in one reactant compared with the other. For example, when reacting a diol with an organo-functional silane typically 2.5 mol of organo-functional silane is required for each mol of diol. For example when reacting a triol with an organo-functional silane typically 4 mol of organo-functional silane is required for each mol of diol. For example when reacting a tetra-ol with an organo-functional silane typically 5 mol of organo-functional silane is required for each mol of diol.

Process for Assessing the Compatibility of Glass Reinforcing Fibre with the Surface Tension Modified Resin

Preferably the glass roving is chosen for its compatibility with the surface tension modified resin. In one embodiment the selection criteria steps comprise the following:

1. Chop 200 g of glass fibre (roving) using the roving cutter on the depositor.

2. Evenly distribute 15 to 20 g of the chopped roving over a flat mould surface to produce a circular mat about 200 mm in diameter. Catalyse 40 grams of surface tension modified resin and pour into the middle of the circular mat of chopped roving.

3. Allow the resin to spread out and wet the roving. When the composite has exothermed and cooled to room temperature, release the composite, which can then be held up to a bright light to compare its appearance with an “ideal” panel (i.e. one that is extensively hand consolidated). For example, a comparison can be made of the amount, size and position of air bubbles, and whether jackstrawing/spiderwebbing is present. Also, the diameter of the wetted glass laminate may be compared with that of an “ideal” panel. Preferably the air bubbles (if present) should be few in number and only present in the outer-third of the panel. Preferably no air bubbles in the middle two-thirds of the panel should be larger than 1 mm in diameter.

4. If a glass fibre is found to have these properties a trial laminate can be sprayed onto a vertical mould surface with the depositor and the glass under test. When this laminate is fully cured it may then be removed from the mould and test samples can be cut therefrom and tested for the required physical and chemical properties. If the panel has acceptable mechanical properties then the glass fibre roving is suitable for use with a resin modified according to the present invention.

### INDUSTRIAL APPLICABILITY

The present invention is useful in a wide variety of industries, including: composite fabrication, construction, automotive, aerospace, marine and for corrosion resistant products. The reinforced composite material of the invention provides improved long-term mechanical properties compared to traditional glass fibre reinforced materials.

Although the invention has been described with reference to specific examples, it will be appreciated by those skilled in the art that the invention may be embodied in many other forms.

1. A method for producing a fibre reinforced composite material, comprising: contacting a plurality of reinforcing fibres with a curable resin mixture and curing said curable resin mixture, said curable resin mixture comprising a curable resin and a predetermined quantity of surface tension modifier prepared by reacting a polyol with an organo-functional silane.

2. A method for producing a composite material, comprising: combining a plurality of reinforcing fibres with a curable resin mixture to form a composition; applying said composition to a mould and curing said curable resin, said curable resin mixture comprising a curable resin and a predetermined quantity of surface tension modifier prepared by reacting a polyol with an organo-functional silane.

3. A method according to claim 1 wherein said reinforcing fibre is glass fibre optionally coated with a coupling agent.

4. A method according to claim 3 wherein said coupling agent is selected from the group consisting of Dow® Z-6030, Z-6032, and Z-6075.

5. A method according to claim 3 wherein the length of said glass fibre is between about 5 and 50 mm.

6. A method according to claim 1 wherein said curable resin is an unsaturated polyester resin.

7. A method according to claim 6 wherein said unsaturated polyester resin is Derakane® epoxy vinyl ester resin 411-350.

8. A method according to claim 1 wherein said surface tension modifier is combined with said curable resin at between about 1 to 5% w/w.

9. A method according to claim 1 wherein said polyol is chosen from trimetholylpropane or pentaerythritol.

10. A method according to claim 1 wherein said organo-functional silane is a trialkoxysilane (RSi(OR′)₃).

11. A method according to claim 9 wherein said trialkoxysilane is chosen from the group consisting of Dynasylan® OCTEO, DOW® Z6341, Dynasylan® GLYMO, DOW® Z6040, Dynasylan® IBTEO, DOW® Z2306, Dynasylan® AMEO, DOW® Z6020, Dynasylan® MEMO, DOW® Z6030, DOW® Z6032, DOW® Z6172, DOW® Z6300, DOW® Z6011, Dynasylan 9116 and DOW® Z6075.

12. A method according to claim 1 wherein said surface tension modifier is prepared by reacting a polyol with an organo-functional silane in the presence of heat and a catalyst.

13. A method according to claim 12 wherein said catalyst is a tin-based catalyst.

14. A method according to claim 1 further including at least one reactive diluent and/or thixotropic agent.

15. A method according to claim 14 wherein said thixotropic agent is silica, precipitated silica, hydrogenated caster oils or amide thixatropes.

16. A method according to claim 14 wherein said reactive diluent is chosen from the group consisting of ethyl acrylate, butyl acrylate, HEMA, IBMA, MMA, isobornyl methacrylate and styrene.

17. A method according to any one of claim 14 wherein about 5% to about 30% of said reactive diluent is be added to said curable resin.

18. A method according to claim 1 wherein a contact angle of the surface tension modified resin is less than about 30° when said fibres are in contact with said curable resin.

19. A fibre reinforced composite material when produced by a method according to claim 1.

20. A composite material when produced by a method according to claim 1

21-34. (canceled)
